(19) United States
(12) Patent Application Publication
(10) Pub. No.: US 2026/0312468 A1
(43) Pub. Date: Oct. 8, 2026

(54) ELECTRIC MOTOR AND CONTROL DEVICE

(71) Applicant: FANUC CORPORATION, Yamanashi (JP)

(72) Inventor: Yuusuke FUKUSHIMA, Yamanashi (JP)

(21) Appl. No.: 19/108,176

(22) PCT Filed: Oct. 7, 2022
(86) PCT No.: PCT/JP2022/037642

§ 371 Date: Mar. 3, 2025

(51) Int. Cl. H02K 11/25; H02P 29/64

(52) U.S. Cl. CPC H02K 11/25; H02P 29/64

(57) ABSTRACT

This electric motor comprises: a stator core; a first winding that is wound around the stator core and corresponds to a first phase; a second winding that is wound around the stator core and that corresponds to a second phase which is different from the first phase; a thermistor that is attached to the first winding; and a thermostat that is connected in series with the thermistor, and that is attached to the second winding.

### RELATED APPLICATIONS

The present application is a National Phase of International Application No. PCT/JP 2022/037642 filed Oct. 7, 2022.

### TECHNICAL FIELD

The present disclosure relates generally to an electric motor and a controller.

### BACKGROUND ART

Conventionally, to prevent a winding wire of an electric motor from overheating and burning out, there has been known technology for measuring a temperature of the winding wire using a temperature sensor and stopping the electric motor when the temperature exceeds a predetermined temperature (for example, Patent Document 1). For example, a thermistor or a thermostat is used as the temperature sensor.

### CITATION LIST

### Patent Document

Patent Document 1: WO 2018/021043

### BRIEF DESCRIPTION OF THE DRAWINGS

FIG. 1 is a diagram for describing an electric motor;

FIG. 2 is a schematic diagram illustrating an example of an aspect in which each of a thermistor and a thermostat is attached to each winding wire;

FIG. 3 is a graph illustrating an example of temperature characteristics of the thermistor and the thermostat;

FIG. 4 is a schematic diagram illustrating an example of an aspect in which each of the thermistor and the thermostat is attached to each winding wire;

FIG. 5 is a schematic diagram illustrating an example of an aspect in which each of the thermistor and the thermostat is attached to each winding wire;

FIG. 6 is a schematic diagram illustrating an example of an aspect in which each of the thermistor and the thermostat is attached to each winding wire;

FIG. 7 is a block diagram illustrating an example of a hardware configuration of a controller;

FIG. 8 is a block diagram illustrating an example of functions of the controller; and

FIG. 9 is a flowchart illustrating an example of processing executed by the controller.

### DETAILED DESCRIPTION

According to the disclosure, an electric motor of the disclosure includes a stator core, a first winding wire wound around the stator core and forming a first phase, a second winding wire wound around the stator core and forming a second phase different from the first phase, a thermistor attached to the first winding wire, and a thermostat connected in series to the thermistor and attached to the second winding wire.

A controller of the disclosure includes a detection unit configured to detect composite resistance between resistance of a thermistor wound around a stator core of an electric motor and attached to a first winding wire forming a first phase and resistance of a thermostat wound around the stator core, attached to a second winding wire forming a second phase different from the first phase, and connected in series to the thermistor, and an output unit configured to output an alarm when a value of the composite resistance detected by the detection unit becomes greater than or equal to a first reference value or less than or equal to a second reference value.

Hereinafter, an electric motor and a controller according to an embodiment of the disclosure will be described with reference to the drawings. Note that, in the following description, components having the same or similar functions are denoted by the same reference numerals. Furthermore, duplicate descriptions of those components may be omitted.

In this application, “based on XX” means “based on at least XX”, and the case of “based on other elements in addition to XX” is also to be included. Furthermore, “based on XX” is not limited to the case where XX is directly used, and includes the case of “based on an element obtained by calculating or processing XX”. “XX” is any element (for example, any information).

### First embodiment

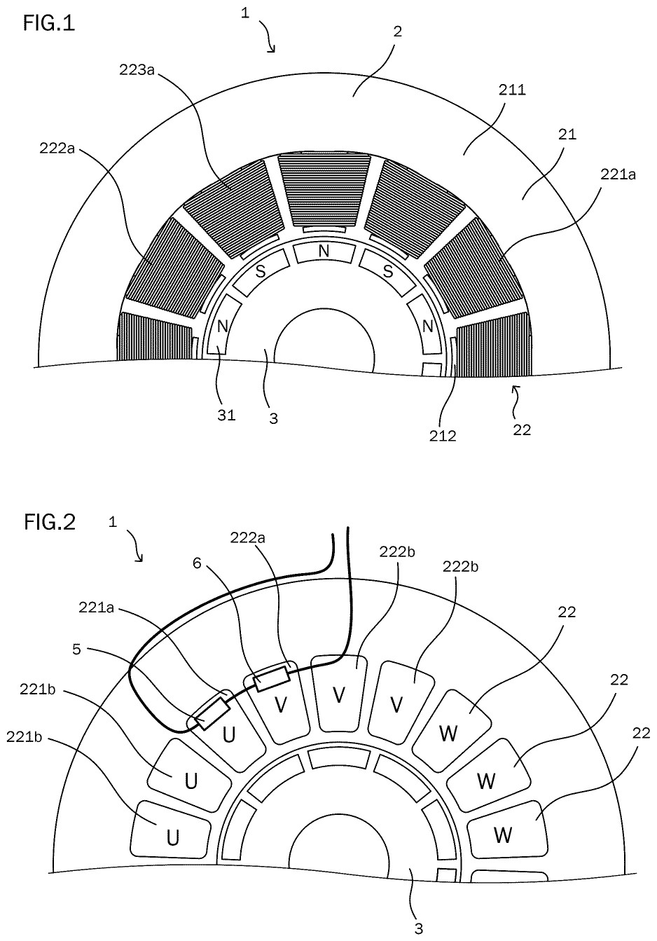

FIG. 1 is a diagram for describing an electric motor. The electric motor 1 is, for example, a three-phase AC electric motor. The electric motor 1 is not limited to the three-phase AC electric motor, and may be a single-phase AC electric motor. The electric motor 1 may also be a DC electric motor. The DC electric motor is, for example, a brushless DC (Direct Current) electric motor. Note that each embodiment will be described below using the three-phase AC electric motor.

The electric motor 1 includes a stator 2 and a rotor 3. The stator 2 includes a stator core 21 and a plurality of winding wires 22. The plurality of winding wires 22 includes, for example, a first winding wire 221a, a second winding wire 222a, and a third winding wire 223a.

The stator core 21 is formed, for example, by stacking a plurality of electromagnetic steel sheets. The electromagnetic steel sheets are processed into a predetermined shape, for example, by pressing. The stator core 21 includes a ring-shaped yoke 211 and a plurality of teeth 212 protruding from an inner periphery of the yoke 211 toward a central axis of the stator core 21.

The first winding wire 221a is wound around the teeth 212 of the stator core 21. The first winding wire 221a is made of, for example, a copper wire. The first winding wire 221a is a winding wire that forms a first phase. The first phase is, for example, a U-phase.

The second winding wire 222a is wound around the teeth 212 of the stator core 21. The second winding wire 222a is made of, for example, a copper wire. The second winding wire 222a is a winding wire that forms a second phase different from the first phase. The second phase is, for example, a V-phase.

The third winding wire 223a is wound around the teeth 212 of the stator core 21. The third winding wire 223a is made of, for example, a copper wire. The third winding wire 223a is a winding wire that forms a third phase different from the first phase and the second phase. The third phase is, for example, a W-phase.

The rotor 3 includes, for example, a permanent magnet 31. The rotor 3 rotates due to a magnetic force acting between the stator 2 and the rotor 3.

The stator 2 further includes a thermistor (not illustrated) and a thermostat (not illustrated). The thermistor is an electronic component whose resistance value changes in response to a change in temperature. The thermistor is, for example, an NTC (negative temperature coefficient) thermistor. The NTC thermistor is a thermistor whose resistance value gradually decreases in response to an increase in temperature.

The thermistor may be a PTC (positive temperature coefficient) thermistor. The PTC thermistor is a thermistor whose resistance value increases in response to an increase in temperature.

The thermostat is an electronic component whose resistance value is 0 [Ω] at a predetermined temperature or less and whose resistance value becomes infinite when the predetermined temperature is exceeded. In other words, the thermostat is a switch that is turned on at the predetermined temperature or less and turned off when the predetermined temperature is exceeded.

FIG. 2 is a schematic diagram illustrating an example of an aspect in which each of the thermistor and the thermostat is attached to each winding wire. Each of the thermistor 5 and the thermostat 6 is fixed to each winding wire using an adhesive. Each of the thermistor 5 and the thermostat 6 may be fixed to each winding wire using a fastener, etc. without being limited to the adhesive.

The electric motor 1 includes the first winding wire 221a forming the first phase and the second winding wire 222a forming the second phase different from the first phase. The first phase is, for example, a U-phase. The second phase is, for example, a V-phase.

The thermistor 5 is attached to the first winding wire 221a. The thermostat 6 is attached to the second winding wire 222a. In other words, the winding wire to which the thermistor 5 is attached is the first winding wire 221a. In addition, the winding wire to which the thermostat 6 is attached is the second winding wire 222a.

The electric motor 1 further includes one or more first sub-winding wires 221b forming the first phase and one or more second sub-winding wires 222b forming the second phase. The one or more first sub-winding wires 221b are one or more winding wires which form the same phase as that of the first winding wire 221a and to which neither the thermistor 5 nor the thermostat 6 is attached. In addition, the one or more second sub-winding wires 222b are one or more winding wires which form the same phase as that of the second winding wire 222a and to which neither the thermistor 5 nor the thermostat 6 is attached.

The one or more first sub-winding wires 221b, together with the first winding wire 221a, form a row of winding wires that are continuous in a circumferential direction of the stator core 21. In other words, the first winding wire 221a and the one or more first sub-winding wires 221b are continuously disposed in the circumferential direction of the stator core 21 to form a first row. In the example illustrated in FIG. 2, two first sub-winding wires 221b are disposed side by side in the circumferential direction of the stator core 21 together with the first winding wire 221a.

The one or more second sub-winding wires 222b, together with the second winding wire 222a, form a row of winding wires that are continuous in the circumferential direction of the stator core 21. In other words, the second winding wire 222a and the one or more second sub-winding wires 222b are continuously disposed in the circumferential direction of the stator core 21 to form a second row. In the example illustrated in FIG. 2, two second sub-winding wires 222b are disposed side by side in the circumferential direction of the stator core 21 together with the second winding wire 222a.

The electric motor 1 further includes the plurality of winding wires 22 forming the third phase. The third phase is, for example, the W-phase. The plurality of winding wires 22 forming the third phase forms a row of winding wires that are continuous in the circumferential direction of the stator core 21. The thermistor 5 and the thermostat 6 are not attached to the plurality of winding wires 22 forming the third phase.

The thermostat 6 is connected in series to the thermistor 5. A temperature of the first winding wire 221a and a temperature of the second winding wire 222a are measured based on composite resistance of resistance of the thermistor 5 and resistance of the thermostat 6.

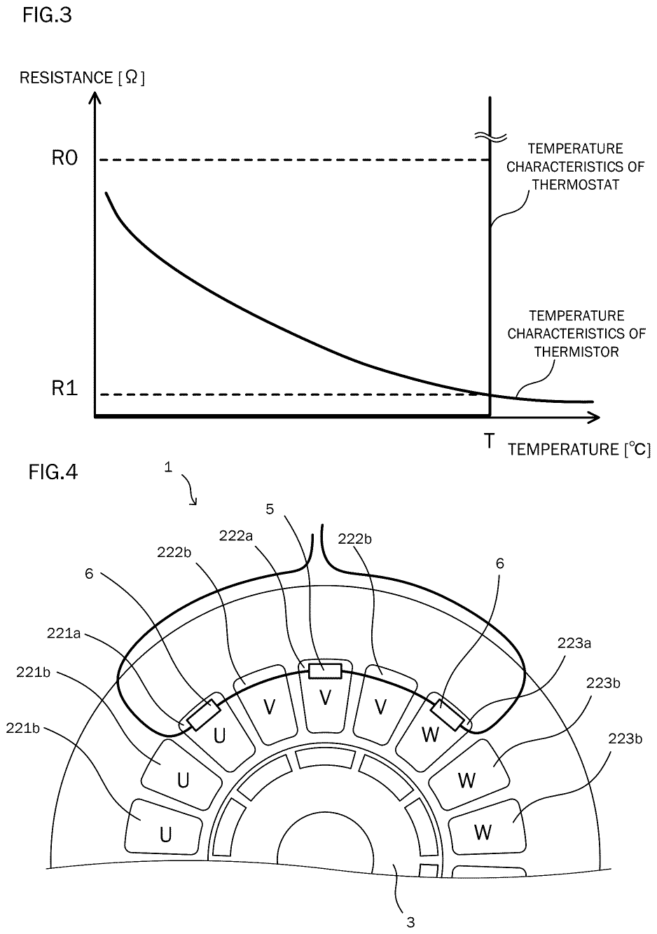

FIG. 3 is a graph illustrating an example of temperature characteristics of the thermistor 5 and the thermostat 6 attached to the first winding wire 221a and the second winding wire 222a, respectively. A curve indicating that a resistance value decreases as a temperature increases is a line indicating the temperature characteristics of the thermistor 5. Meanwhile, a line depicted so that resistance is 0 [Ω] when the temperature is a predetermined temperature T [° C.] or less and resistance becomes infinite when the temperature exceeds the predetermined temperature T [° C.] is a line indicating the temperature characteristics of the thermostat 6. Here, the resistance of 0 [Ω] does not have to be 0 [Ω] exactly, and may be resistance close to 0 [Ω]. A resistance value of the thermostat 6 at the predetermined temperature T [° C.] or less is, for example, resistance of copper.

When a value of the composite resistance is less than a predetermined first reference value R1 [Ω], the value of the composite resistance is the same as the resistance value of the thermistor 5. A reason therefor is that the resistance value of the thermostat 6 is 0 [Ω] unless the resistance value is infinite. Therefore, when the value of the composite resistance is less than the first reference value R1 [Ω], the temperature of the first winding wire 221a can be measured based on the value of the composite resistance. For example, it is possible to measure the temperature of the first winding wire 221a in real time while the electric motor 1 is driven.

However, when the value of the composite resistance is less than or equal to a second reference value R2 [Ω], the temperature of the first winding wire 221a becomes greater than or equal to the predetermined temperature T [° C.]. In other words, the first winding wire 221a is overheated. In this case, supply of power to the electric motor 1 may be suspended. In addition, as described later, an alarm may be output.

When the value of the composite resistance is greater than or equal to the first reference value R1 [Ω], that is, when the value becomes infinite, the temperature of the thermostat 6 is greater than or equal to the predetermined temperature T [° C.]. In other words, the second winding wire 222a is overheated. In this case, supply of power to the electric motor 1 may be suspended. In addition, as described later, an alarm may be output.

### Second Embodiment

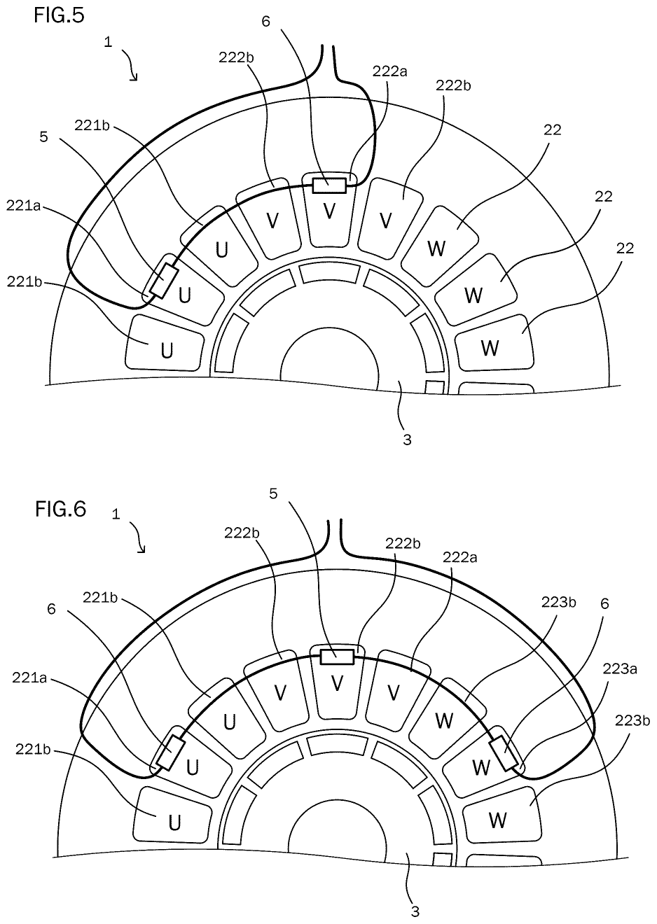

FIG. 4 is a schematic diagram illustrating an example of an aspect in which each of the thermistor 5 and the thermostat 6 is attached to each winding wire.

The electric motor 1 includes a first winding wire 221a forming a first phase, a second winding wire 222a forming a second phase different from the first phase, and a third winding wire 223a forming a third phase different from the first phase and the second phase. The first phase is, for example, a U-phase. The second phase is, for example, a V-phase. The third phase is, for example, a W-phase.

The thermistor 5 is attached to the second winding wire 222a. In other words, a winding wire to which the thermistor 5 is attached is the second winding wire 222a. The thermostat 6 is attached to each of the first winding wire 221a and the third winding wire 223a. In other words, a winding wire to which the thermostat 6 is attached is the first winding wire 221a and the third winding wire 223a.

The electric motor 1 further includes one or more first sub-winding wires 221b forming the first phase, one or more second sub-winding wires 222b forming the second phase, and one or more third sub-winding wires 223b forming the third phase.

The one or more first sub-winding wires 221b are one or more winding wires which form the same phase as that of the first winding wire 221a and to which neither thermistor 5 nor thermostat 6 is attached. The one or more second sub-winding wires 222b are one or more winding wires which form the same phase as that of the second winding wire 222a and to which neither thermistor 5 nor thermostat 6 is attached. The one or more third sub-winding wires 223b are one or more winding wires which form the same phase as that of the third winding wire 223a and to which neither thermistor 5 nor thermostat 6 is attached.

The one or more first sub-winding wires 221b, together with the first winding wire 221a, form a row of winding wires that are continuous in the circumferential direction of the stator core 21. In other words, the first winding wire 221a and the one or more first sub-winding wires 221b are continuously disposed in the circumferential direction of the stator core 21 to form a first row. In the example illustrated in FIG. 4, two first sub-winding wires 221b are disposed side by side in the circumferential direction of the stator core 21 together with the first winding wire 221a.

The one or more second sub-winding wires 222b, together with the second winding wire 222a, form a row of winding wires that are continuous in the circumferential direction of the stator core 21. In other words, the second winding wire 222a and the one or more second sub-winding wires 222b are continuously disposed in the circumferential direction of the stator core 21 to form a second row. In the example illustrated in FIG. 4, two second sub-winding wires 222b are disposed side by side in the circumferential direction of the stator core 21 together with the second winding wire 222a.

The one or more third sub-winding wires 223b, together with the third winding wire 223a, form a row of winding wires that are continuous in the circumferential direction of the stator core 21. In other words, the third winding wire 223a and the one or more third sub-winding wires 223b are continuously disposed in the circumferential direction of the stator core 21 to form a third row. In the example illustrated in FIG. 4, two third sub-winding wires 223b are disposed side by side in the circumferential direction of the stator core 21 together with the third winding wire 223a.

The two thermostats 6 are connected in series to the thermistor 5. Note that the two thermostats 6 are also connected in series to each other. A temperature of the first winding wire 221a, a temperature of the second winding wire 222a, and a temperature of the third winding wire 223a are measured based on composite resistance of resistance of the thermistor 5 and resistance of the two thermostats 6.

When a value of the composite resistance is less than the first reference value R1 [Ω], the value of the composite resistance is the same as a resistance value of the thermistor 5. A reason therefor is that the resistance of the thermostat 6 is 0 [Ω] unless the resistance is infinite. Therefore, when the value of the composite resistance is less than the first reference value R1 [Ω], the temperature of the second winding wire 222a can be measured based on the value of the composite resistance. For example, it is possible to measure the temperature of the second winding wire 222a in real time while the electric motor 1 is driven.

However, when the value of the composite resistance is less than or equal to the second reference value R2 [Ω], the temperature of the second winding wire 222a becomes greater than or equal to the predetermined temperature T [° C.]. In other words, the second winding wire 222a is overheated. In this case, supply of power to the electric motor 1 may be suspended.

When the value of the composite resistance is greater than or equal to the first reference value R1 [Ω], that is, infinite, a temperature of at least one of the two thermostats 6 is greater than or equal to the predetermined temperature T [° C.]. In other words, at least one of the first winding wire 221a and the third winding wire 223a is overheated. In this case, for example, supply of power to the electric motor 1 may be suspended.

### Third Embodiment

FIG. 5 is a schematic diagram illustrating an example of an aspect in which each of the thermistor 5 and the thermostat 6 is attached to each winding wire.

The electric motor 1 includes a first winding wire 221a forming a first phase and a second winding wire 222a forming a second phase different from the first phase. The first phase is, for example, a U-phase. The second phase is, for example, a V-phase.

The thermistor 5 is attached to the first winding wire 221a. The thermostat 6 is attached to the second winding wire 222a. In other words, a winding wire to which the thermistor 5 is attached is the first winding wire 221a. In addition, a winding wire to which the thermostat 6 is attached is the second winding wire 222a.

The electric motor 1 further includes one or more first sub-winding wires 221b forming the first phase and one or more second sub-winding wires 222b forming the second phase. The one or more first sub-winding wires 221b are one or more winding wires which form the same phase as that of the first winding wire 221a and to which neither the thermistor 5 nor the thermostat 6 is attached. The one or more second sub-winding wires 222b are one or more winding wires which form the same phase as that of the second winding wire 222a and to which neither the thermistor 5 nor the thermostat 6 is attached.

The one or more first sub-winding wires 221b, together with the first winding wire 221a, form a row of winding wires that are continuous in the circumferential direction of the stator core 21. In other words, the first winding wire 221a and the one or more first sub-winding wires 221b are continuously disposed in the circumferential direction of the stator core 21 to form a first row.

Furthermore, the first winding wire 221a is disposed at a center of the first row. Here, the center means that the same numbers of first sub-winding wires 221b are disposed on both sides of the first winding wire 221a in the circumferential direction of the stator core 21. For example, when the total number of the first winding wire 221a and the one or more first sub-winding wires 221b is three, one first sub-winding wire 221b is disposed on each side of the first winding wire 221a.

However, the numbers of first sub-winding wires 221b disposed on both sides of the first winding wire 221a in the circumferential direction of the stator core 21, respectively, do not necessarily have to be strictly the same. For example, when the total number of the first winding wire 221a and the first sub-winding wires 221b is four, the first winding wire 221a may be any one of two winding wires closer to the center. That is, one first sub-winding wire 221b is disposed on one side of the first winding wire 221a, and two first sub-winding wires 221b are disposed on the other side. This case is also included in the concept that the first winding wire 221a is disposed at the center of the first row.

The one or more second sub-winding wires 222b, together with the second winding wire 222a, form a row of winding wires that are continuous in the circumferential direction of the stator core 21. In other words, the second winding wire 222a and the one or more second sub-winding wires 222b are disposed continuously in the circumferential direction of the stator core 21 to form a second row.

Furthermore, the second winding wire 222a is disposed at a center of the second row. Here, the center means that the same numbers of second sub-winding wires 222b are disposed on both sides of the second winding wire 222a in the circumferential direction of the stator core 21. However, the numbers of second sub-winding wires 222b disposed on both sides of the second winding wire 222a in the circumferential direction of the stator core 21, respectively, do not necessarily have to be strictly the same. For example, when the total number of the second winding wire 222a and the second sub-winding wires 222b is four, the second winding wire 222a may be any one of two winding wires closer to the center. This case is also included in the concept that the second winding wire 222a is disposed at the center of the second row.

The electric motor 1 further includes a plurality of winding wires 22 forming a third phase. The third phase is, for example, a W-phase. The plurality of winding wires 22 form a row of winding wires that are continuous in the circumferential direction of the stator core 21. The thermistor 5 and the thermostat 6 are not attached to the plurality of winding wires 22 forming the third phase.

The thermostat 6 is connected in series to the thermistor 5. A temperature of the first winding wire 221a and a temperature of the second winding wire 222a are measured based on composite resistance of the thermistor 5 and resistance of the thermostat 6.

When a value of the composite resistance is less than the first reference value R1 [Ω], the value of the composite resistance is approximately the same as the resistance of the thermistor 5. A reason therefor is that the resistance of the thermostat 6 is 0 [Ω] unless the resistance is infinite. Therefore, when the value of the composite resistance is less than the first reference value R1 [Ω], the temperature of the first winding wire 221a can be measured based on the value of the composite resistance.

However, when the value of the composite resistance is less than or equal to the second reference value R2 [Ω], the temperature of the first winding wire 221a becomes greater than or equal the predetermined temperature T [° C.]. In other words, the first winding wire 221a is overheated. In this case, supply of power to the electric motor 1 may be suspended.

In this embodiment, the first winding wire 221a to which the thermistor 5 is attached is disposed at a center of the first row. For this reason, when only the winding wire 22 forming the first phase is overheated, this overheating can be detected more reliably.

When the value of the composite resistance is greater than or equal to the first reference value R1 [Ω], that is, becomes infinite, the temperature of the thermostat 6 is greater than or equal to the predetermined temperature T [° C.]. In other words, the second winding wire 222a is overheated. In this case, for example, supply of power to the electric motor 1 may be suspended.

In this embodiment, the second winding wire 222a to which the thermostat 6 is attached is disposed at the center of the second row. For this reason, when only the winding wire 22 forming the second phase is overheated, this overheating can be detected more reliably.

### Fourth Embodiment

FIG. 6 is a schematic diagram illustrating an example of an aspect in which each of the thermistor 5 and the thermostat 6 is attached to each winding wire.

The electric motor 1 includes a first winding wire 221a forming a first phase, a second winding wire 222a forming a second phase different from the first phase, and a third winding wire 223a forming a third phase different from the first phase and the second phase. The first phase is, for example, a U-phase. The second phase is, for example, a V-phase. The third phase is, for example, a W-phase.

The thermistor 5 is attached to the second winding wire 222a. In other words, a winding wire to which the thermistor 5 is attached is the second winding wire 222a. The thermostat 6 is attached to each of the first winding wire 221a and the third winding wire 223a. In other words, a winding wire to which the thermostat 6 is attached is the first winding wire 221a and the third winding wire 223a.

The electric motor 1 further includes one or more first sub-winding wires 221b forming the first phase, one or more second sub-winding wires 222b forming the second phase, and one or more third sub-winding wires 223b forming the third phase.

Meanings of the one or more first sub-winding wires 221b and the one or more second sub-winding wires 222b are as described above. The one or more third sub-winding wires 223b are one or more winding wires which form the same phase as that of the third winding wire 223a and to which neither thermistor 5 nor thermostat 6 is attached.

The one or more first sub-winding wires 221b, together with the first winding wire 221a, form a row of winding wires that are continuous in the circumferential direction of the stator core 21. In other words, the first winding wire 221a and the one or more first sub-winding wires 221b are continuously disposed in the circumferential direction of the stator core 21 to form a first row.

In addition, the first winding wire 221a is disposed at a center of the first row.

The one or more second sub-winding wires 222b, together with the second winding wire 222a, form a row of winding wires that are continuous in the circumferential direction of the stator core 21. In other words, the second winding wire 222a and the one or more second sub-winding wires 222b are disposed continuously in the circumferential direction of the stator core 21 to form a second row. In addition, the second winding wire 222a is disposed at a center of the second row.

The one or more third sub-winding wires 223b, together with the third winding wire 223a, form a row of winding wires that are continuous in the circumferential direction of the stator core 21. In other words, the third winding wire 223a and the one or more third sub-winding wires 223b are continuously disposed in the circumferential direction of the stator core 21 to form a third row. In addition, the third winding wire 223a is disposed at a center of the third row.

Here, the center means that the same numbers of third sub-winding wires 223b are disposed on both sides of the third winding wire 223a in the circumferential direction of the stator core 21. However, the numbers of third sub-winding wires 223b disposed on both sides of the third winding wire 223a in the circumferential direction of the stator core 21, respectively, do not necessarily have to be strictly the same. For example, when the total number of the third winding wire 223a and the third sub-winding wires 223b is four, the third winding wire 223a may be any one of two winding wires 22 closer to the center. This case is also included in the concept that the third winding wire 223a is disposed at the center of the third row.

The two thermostats 6 are connected in series to the thermistor 5. Note that the two thermostats 6 are also connected in series to each other. Temperatures of the first winding wire 221a, the second winding wire 222a, and the third winding wire 223a are measured based on composite resistance of resistance of the thermistor 5 and resistances of the two thermostats 6.

When a value of the composite resistance is less than the first reference value R1 [Ω], the value of the composite resistance is the same as the resistance of the thermistor 5. A reason therefor is that the resistance of the thermostat 6 is 0 [Ω] unless the resistance is infinite. Therefore, when the value of the composite resistance is less than the first reference value R1 [Ω], the temperature of the second winding wire 222a can be measured based on the value of the composite resistance.

However, when the value of the composite resistance is less than or equal to the second reference value R2 [Ω], the temperature of the second winding wire 222a becomes greater than or equal the predetermined temperature T [° C.]. In other words, the second winding wire 222a is overheated. In this case, supply of power to the electric motor 1 may be suspended.

In this embodiment, the second winding wire 222a to which the thermistor 5 is attached is disposed at the center of the second row. For this reason, when only the winding wire 22 forming the second phase is overheated, this overheating can be detected more reliably.

When the value of the composite resistance is greater than or equal to the first reference value R1 [Ω], that is, when the value becomes infinite, a temperature of at least one of the two thermostats 6 is greater than or equal to the predetermined temperature T [° C.]. In other words, at least one of the first winding wire 221a and the third winding wire 223a is overheated. In this case, supply of power to the electric motor 1 may be suspended.

In this embodiment, the first winding wire 221a and the third winding wire 223a, to each of which the thermostat 6 is attached, are disposed at the center of the first row and the center of the third row, respectively. For this reason, when only the winding wire 22 forming the first phase is overheated, or when only the winding wire 22 forming the third phase is overheated, this overheating can be detected more reliably.

### Fifth Embodiment

Next, a description will be given of the controller that outputs an alarm when a temperature detected from the electric motor 1 exceeds a predetermined temperature. The controller is, for example, a controller that controls the electric motor 1. The electric motor 1 is at least any one of the electric motors 1 disclosed in the first to fourth embodiments described above.

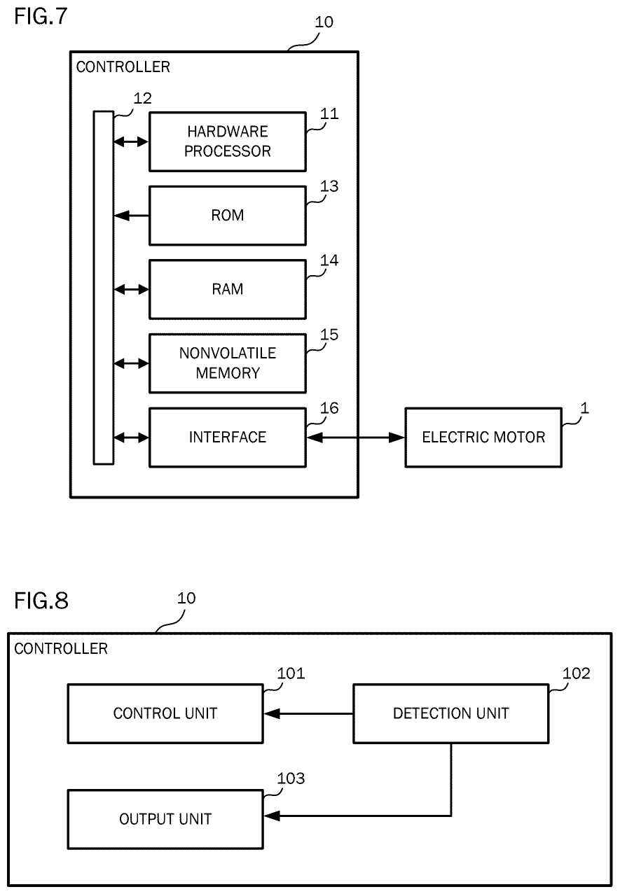

FIG. 7 is a block diagram illustrating an example of a hardware configuration of the controller. The controller 10 is, for example, a numerical controller that controls an industrial machine. The controller 10 may be a computer such as a personal computer (PC), a server, or a tablet terminal.

The controller 10 includes a hardware processor 11, a bus 12, a read only memory (ROM) 13, a random access memory (RAM) 14, a nonvolatile memory 15, and an interface 16.

The hardware processor 11 is a processor that controls the entire controller 10 in accordance with a system program. The hardware processor 11 reads a system program stored in the ROM 13 via the bus 12, and performs various processes based on the system program. The hardware processor 11 is, for example, a central processing unit (CPU) or an electronic circuit.

The bus 12 is a communication path that connects respective pieces of hardware in the controller 10 to each other. The respective pieces of hardware in the controller 10 exchange data via the bus 12.

The ROM 13 is a storage device that stores a system program for controlling the entire controller 10. The ROM 13 is a computer-readable storage medium.

The RAM 14 is a storage device that temporarily stores various data. The RAM 14 functions as a working area for the hardware processor 11 to process various data.

The nonvolatile memory 15 is a storage device that retains data even when the controller 10 is turned off and power is not being supplied to the controller 10. The nonvolatile memory 15 is a computer-readable storage medium. The nonvolatile memory 15 is configured, for example, as a battery-backed memory or a solid state drive (SSD).

The interface 16 connects the bus 12 and the electric motor 1 to each other. The controller 10 transmits and receives data to and from the electric motor 1 via the interface 16.

FIG. 8 is a block diagram illustrating an example of functions of the controller 10. The controller 10 includes, for example, a control unit 101, a detection unit 102, and an output unit 103. The control unit 101, the detection unit 102, and the output unit 103 are realized, for example, by the hardware processor 11 performing calculation processing using a system program stored in the ROM 13 and various data stored in the nonvolatile memory 15.

For example, the control unit 101 controls an operation of the electric motor 1 based on an operating program stored in a storage unit (not illustrated).

The detection unit 102 detects the composite resistance of the resistance of the thermistor 5 and the resistance of the thermostat 6. The thermistor 5 is attached to, for example, the first winding wire 221a wound around the stator core 21 of the electric motor 1 and forming the first phase. The thermostat 6 is attached to the second winding wire 222a wound around the stator core 21 and forming the second phase different from the first phase. In addition, the thermostat 6 is connected in series to the thermistor 5.

The output unit 103 outputs an alarm when a value of the composite resistance detected by the detection unit 102 becomes greater than or equal to the first reference value or less than or equal to the second reference value. For example, the output unit 103 outputs the alarm to a display device (not illustrated) included in the controller 10. The output unit 103 may output the alarm using a rotating light connected to the controller 10.

Moreover, when the value of the composite resistance detected by the detection unit 102 becomes greater than or equal to the first reference value or less than or equal to the second reference value, the control unit 101 stops the operation of the electric motor 1.

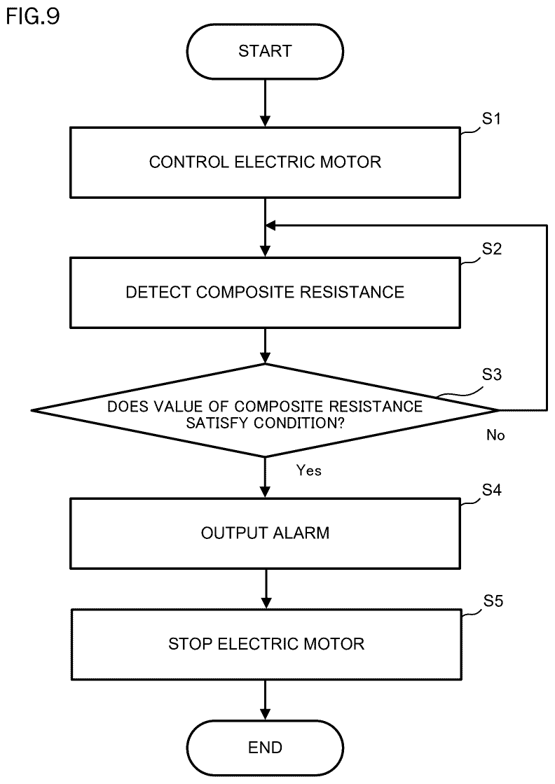

FIG. 9 is a flowchart illustrating an example of processing executed by the controller 10. First, the control unit 101 of the controller 10 controls the electric motor 1 (step S1).

Next, the detection unit 102 detects the composite resistance of the thermistor 5 and the thermostat 6 (step S2). Next, the detection unit 102 determines whether or not the value of the composite resistance satisfies a predetermined condition (step S3). Specifically, the detection unit 102 determines whether or not the value of the composite resistance is greater than or equal to the first reference value or less than or equal to the second reference value.

When the composite resistance does not satisfy the predetermined condition (No in step S3), the detection unit 102 continues detecting the composite resistance.

When the composite resistance satisfies the predetermined condition (Yes in step S3), the output unit 103 outputs an alarm (step S4). Furthermore, the control unit 101 stops the operation of the electric motor 1 (step S5), and the process ends.

As described above, the electric motor 1 includes the stator core 21, the first winding wire 221a wound around the stator core 21 and forming the first phase, the second winding wire 222a wound around the stator core 21 and forming the second phase different from the first phase, the thermistor 5 attached to the first winding wire 221a, and the thermostat 6 connected in series to thermistor 5 and attached to the second winding wire 222a.

Therefore, even when only one of the first winding wire 221a and the second winding wire 222a is overheated, this overheating can be detected. Furthermore, since the thermistor 5 and the thermostat 6 are connected in series, wiring can be prevented from becoming complicated.

In addition, the electric motor 1 further includes the one or more first sub-winding wires 221b forming the first phase, the first winding wire 221a and the one or more first sub-winding wires 221b are disposed continuously in the circumferential direction of the stator core 21 to form the first row, and the first winding wire 221a is disposed at the center of the first row. In addition, the electric motor 1 further includes the one or more second sub-winding wires 222b forming the second phase, the second winding wire 222a and the one or more second sub-winding wires 222b are disposed continuously in the circumferential direction of the stator core 21 to form the second row, and the second winding wire 222a is disposed at the center of the second row.

For example, when only the winding wire 22 forming the first phase is overheated, the temperature becomes highest near the center of the first row. Meanwhile, temperatures near both ends of the first row become relatively low due to an influence of the surrounding temperature. For this reason, by disposing the first winding wire 221a at the center of the first row, when the winding wire 22 forming the first phase is overheated, this overheating can be detected at an early stage. Similarly, by disposing the second winding wire 222a at the center of the second row, when the winding wire 22 forming the second phase is overheated, this overheating can be detected at an early stage.

In addition, the controller 10 includes the detection unit 102 that detects the composite resistance between the resistance of the thermistor 5 wound around the stator core 21 of the electric motor 1 and attached to the first winding wire 221a forming the first phase and the resistance of the thermostat 6 wound around the stator core 21, attached to the second winding wire 222a forming the second phase different from the first phase, and connected in series to the thermistor 5, and the output unit 103 that outputs an alarm when the value of the composite resistance detected by the detection unit 102 becomes greater than or equal to the first reference value or less than or equal to the second reference value.

Therefore, even when only one of the first winding wire 221a and the second winding wire 222a is overheated, the controller 10 can detect this overheating. In addition, the controller 10 can notify an operator at an early stage that the detection unit 102 has detected overheating.

The present disclosure has been described in detail as above, but is not limited to these embodiments. Thus, various additions, substitutions, modifications, partial deletions and so on may be made to these embodiments without departing from the gist of the disclosure or the spirit of the disclosure as derived from the contents described in the claims and their equivalents. Furthermore, these embodiments can be implemented by combining them. For example, the order of the operations and the order of the processes in these embodiments are provided by way of example, and thus are not limited thereto. Moreover, numeric values or formulars applied to these embodiments, if any, are also not limited thereto.

In regard to the above-described embodiments and their variations, supplementary notes will be disclosed as below.

### Supplementary Note 1

An electric motor comprising: a stator core; a first winding wire wound around the stator core and forming a first phase; a second winding wire wound around the stator core and forming a second phase different from the first phase; a thermistor attached to the first winding wire; and a thermostat connected in series to the thermistor and attached to the second winding wire.

### Supplementary Note 2

The electric motor according to Supplementary Note 1, further comprising one or more first sub-winding wires forming the first phase, wherein the first winding wire and the one or more first sub-winding wires are continuously disposed in a circumferential direction of the stator core to form a first row, and the first winding wire is disposed at a center of the first row.

### Supplementary Note 3

The electric motor according to Supplementary Note 1 or 2, further comprising one or more second sub-winding wires forming the second phase, wherein the second winding wire and the one or more second sub-winding wires are continuously disposed in the circumferential direction of the stator core to form a second row, and the second winding wire is disposed at a center of the second row.

### Supplementary Note 4

A controller comprising: a detection unit configured to detect composite resistance between resistance of a thermistor wound around a stator core of an electric motor and attached to a first winding wire forming a first phase and resistance of a thermostat wound around the stator core, attached to a second winding wire forming a second phase different from the first phase, and connected in series to the thermistor; and an output unit configured to output an alarm when a value of the composite resistance detected by the detection unit becomes greater than or equal to a first reference value or less than or equal to a second reference value.

1. An electric motor comprising:
a stator core;
a first winding wire wound around the stator core and forming a first phase;
a second winding wire wound around the stator core and forming a second phase different from the first phase;
a thermistor attached to the first winding wire; and
a thermostat connected in series to the thermistor and attached to the second winding wire.

2. The electric motor according to claim 1, further comprising one or more first sub-winding wires forming the first phase, wherein the first winding wire and the one or more first sub-winding wires are continuously disposed in a circumferential direction of the stator core to form a first row, and the first winding wire is disposed at a center of the first row.

3. The electric motor according to claim 1, further comprising one or more second sub-winding wires forming the second phase, wherein the second winding wire and the one or more second sub-winding wires are continuously disposed in the circumferential direction of the stator core to form a second row, and the second winding wire is disposed at a center of the second row.

4. A controller comprising:
a detection unit configured to detect composite resistance between resistance of a thermistor wound around a stator core of an electric motor and attached to a first winding wire forming a first phase and resistance of a thermostat wound around the stator core, attached to a second winding wire forming a second phase different from the first phase, and connected in series to the thermistor; and
an output unit configured to output an alarm when a value of the composite resistance detected by the detection unit becomes greater than or equal to a first reference value or less than or equal to a second reference value.
